(19) United States
(12) Patent Application Publication
(10) Pub. No.: US 2024/0286218 A1
(43) Pub. Date: Aug. 29, 2024

(54) HYDROGEN BAKE-OUT USING A LASER AS A HEAT SOURCE

(71) Applicant: Saudi Arabian Oil Company, Dhahran (SA)

(72) Inventors: Ghazi Salman Qahtani, Al Khobar (SA); Abdulrahman Mohammed Alqahtani, Al Khobar (SA); Mohammed Abdulrahman Alshahrani, Dammam (SA); Hasan Ali Alhashmy, Dhahran (SA)

(21) Appl. No.: 18/175,911

(22) Filed: Feb. 28, 2023

(51) Int. Cl. B23K 26/16; B23K 26/082; B23K 26/21

(52) U.S. Cl. CPC B23K 26/16; B23K 26/082; B23K 26/21; B23K 2103/04

(57) ABSTRACT

The disclosure relates to methods to bake-out hydrogen from a metal component using a laser as the heat source. The metal component can be a component of an oil and gas system, such as a pipeline or vessel.

### FIELD

The disclosure relates to methods to bake-out hydrogen from a metal component using a laser as the heat source. The metal component can be a component of an oil and gas system, such as a pipeline or vessel.

### BACKGROUND

Hydrogen embrittlement can result in material subcritical crack propagation, fracture initiation, and catastrophic failure, resulting in a loss of mechanical qualities such as ductility, toughness, and strength in materials such as steel.

Hydrogen atoms can diffuse through a metal, either at high temperatures where the solubility of hydrogen is increased or at low temperatures, assisted by a concentration gradient. Hydrogen atoms can re-combine in minuscule voids of the metal matrix to form hydrogen molecules and create pressure. The pressure can reduce the ductility and/or tensile strength of the metal and cause the metal to crack (hydrogen induced cracking (HIC)). Hydrogen assisted cracking (HAC) can occur in heated zones, such as during welding.

### SUMMARY

The disclosure relates to methods to bake-out hydrogen from a metal component using a laser as the heat source. The metal component can be a component of an oil and gas system, such as a pipeline or vessel. Using a laser can provide relatively good temperature control and/or can allow for in situ use.

The methods of the disclosure can maintain the integrity of the material and reduce (e.g., prevent) hydrogen embrittlement in a component of an oil and gas system (e.g., a pipeline, a vessel). The methods can be performed more efficiently and/or more cost effectively, and/or provide more even heating, relative to certain other methods, such as methods that include the use of a torch or oven as the heat source. The methods can allow for the baking to be performed in situ on an oil and gas asset and/or in areas that are difficult to reach (e.g., an elbow of a pipe) without disassembly. Relative to certain other methods, the methods can reduce the time used to perform the baking process due to the relatively large power induced by the laser. The methods can be automated, such as by combining the laser source with a crawler robot.

In a first aspect, the disclosure provides a method, including using a laser to heat a component including a material having a first hydrogen concentration to remove hydrogen from the material so that the material has a second hydrogen concentration which is less than the first hydrogen concentration. The material includes a metal.

In some embodiments, the component includes a vessel, a pipe and/or a flange.

In some embodiments, during the process of using the laser to heat the component, the component includes a component of a system selected from the group consisting of an oil and gas production system, an oil and gas transportation system, and an oil and gas processing system.

In some embodiments, the metal includes a member selected from the group consisting of steel, iron, nickel, titanium, cobalt, aluminum and copper.

In some embodiments, the metal includes steel. In some embodiments, the laser includes a carbon dioxide laser. In some embodiments, the laser has an average output power of 1 W to 60 kW. In some embodiments, the laser emits at a wavelength of 9 μm to 11 μm. In some embodiments, the laser has a beam diameter of 2.75 mm to 7.5 mm. In some embodiments, the component is heated to a temperature of 315° C. to 426° C. In some embodiments, the laser is scanned, and the laser has a scan speed of 3 m/min to 13.15 m/min. In some embodiments, the first hydrogen concentration is 0.5 μA/cm² to 0.7 μA/cm², and the second hydrogen concentration is 0.35 μA/cm² to 0.6 μA/cm².

In some embodiments, the laser includes a carbon dioxide laser.

In some embodiments, the laser has an average output power of 1 W to 60 kW.

In some embodiments, the laser emits at a wavelength of 9 μm to 11 μm.

In some embodiments, the component is heated to a temperature of 315° C. to 426° C.

In some embodiments, the laser has a beam diameter of 2.75 mm to 7.5 mm.

In some embodiments, the laser is scanned, and the laser has a scan speed of 3 m/min to 13.15 m/min.

In some embodiments, the first hydrogen concentration is 0.5 μA/cm² to 0.7 μA/cm², and the second hydrogen concentration is 0.35 μA/cm² to 0.6 μA/cm².

In some embodiments, the method further includes, before using the laser to heat the component, welding the component.

### BRIEF DESCRIPTION OF THE FIGURES

FIG. 1 depicts a schematic for a method.

FIG. 2 depicts a graph of the energy of the beam as a function of the penetration depth.

FIG. 3 depicts the reflectance of several materials as a function of wavelength as well as the wavelengths of several lasers.

FIG. 4 depicts schematics of components.

FIG. 5 depicts a graph of the bake-out time for stainless steel with different thicknesses as a function of bake-out temperature.

### DETAILED DESCRIPTION

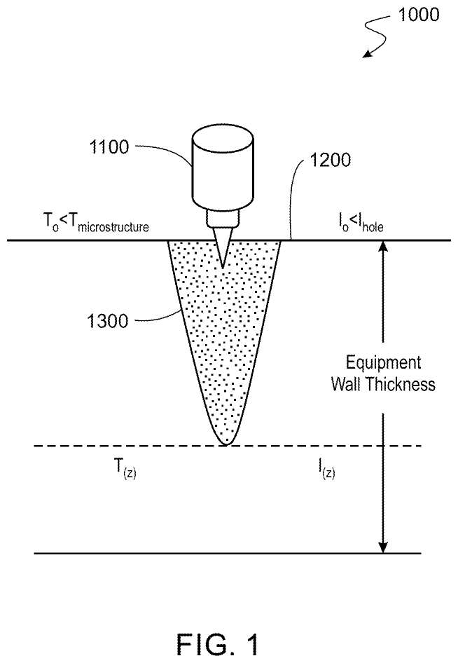

FIG. 1 depicts a schematic of a method 1000 of performing a bake-out. A laser 1100 is used to heat a component 1200, such as a pipe, a vessel or a flange. The laser-induced heating of the component 1200 bakes-out hydrogen from the component 1200 to reduce an amount of hydrogen in the component 1200. A bake-out zone 1300 is defined as the space in the component 1200 heated by the laser 1100 to remove hydrogen. In general, the bake-out zone depends on the laser properties and the material. In general, a deeper penetration is preferred as a greater amount of hydrogen can be baked out. The desired width of the bake-out zone usually depends on the geometry of the material. The laser 1100 can be transported (e.g., by an operator and/or a machine) to cover a relatively large area and/or specific areas of the component 1200 (see discussion below). In general, the selection of parameters for the laser 1100 is case specific and generally depends on the type of laser 1100 and properties of the component 1200 (see discussion below).

As used herein, “hydrogen” refers to hydrogen gas, i.e., H₂. If a different form of hydrogen is intended in this application, then that form of hydrogen is specifically stated. For example, if the intent is to refer to hydrogen atoms, then the application explicitly states “hydrogen atoms.”

Without wishing to be bound by theory, it is believed that the maximum temperature at the surface of the component 1200 can be controlled by Stefan-Boltzmann Law:

$${I}_{0} = ϵ σ {T}_{0}^{4} \qquad Eq . 1$$

where Iₒ is the bake-out intensity at the surface, σ is the Stefan-Boltzmann Constant, which has a value of 5.6697×10⁻⁸ W/m²K⁴, Tₒ is the maximum bake-out temperature at the surface in Kelvin, and ϵ is the emissivity of the component 1200. Tₒ is the maximum bake-out temperature on a surface without changing its microstructure. For steel Tₒ is 727° C. (1000 K), which is the maximum temperature the steel can reach before changing its microstructure from ferrite to austinite. Tₒ will vary depending on the alloy.

Typically, the bake-out intensity Iₒ has a value less than 10⁴-10⁵ W/cm². In some embodiments, using such an Iₒ value results in relatively shallow penetration of the bake-out zone 1300 into the component 1200. Generally, greater intensity is to be avoided because such intensities can cause the metal surface to concave into “holes.” In general, the surface should be heated without changing the microstructure or having any melting or holes in the surface. Higher laser intensities (e.g., at least 10⁴-10⁵ W/cm² for steel) can lead to changing the microstructure which is not desirable. Generally, the intensity Iₒ should be kept below Iₕₒₗₑ which corresponds to an intensity that creates holes in the steel. Similarly, usually Tₒ should be kept below T_{microstructure}, which is the temperature at which the microstructure changes.

Without wishing to be bound by theory, it is believed that as the laser radiation passes through the component 1200, its intensity I(z) decreases, following Eq. 2:

$$I ( z ) = {I}_{0} {e}^{- α z} \qquad Eq . 2$$

where z is the laser penetration depth, α is the material's absorption coefficient and Iₒ is the intensity at the surface (as in Eq. 1). Generally, it is desirable to enhance (e.g., maximize) the penetration depth such that a greater depth of the component 1200 is baked-out. The beam penetration depth I(z) is affected by the properties of the laser 1100, such as its intensity and wavelength, and the properties of the component 1200, such as its emissivity and absorption. For example, increasing the laser intensity and decreasing the laser wavelength can increase the penetration for certain emissivities and absorptions of the component 1200. In general, changing the laser intensity and/or wavelength will lead to change in the material's ability to absorb heat. The temperature at a penetration depth z, T(z), can be determined using I(z) in Eq. 1.

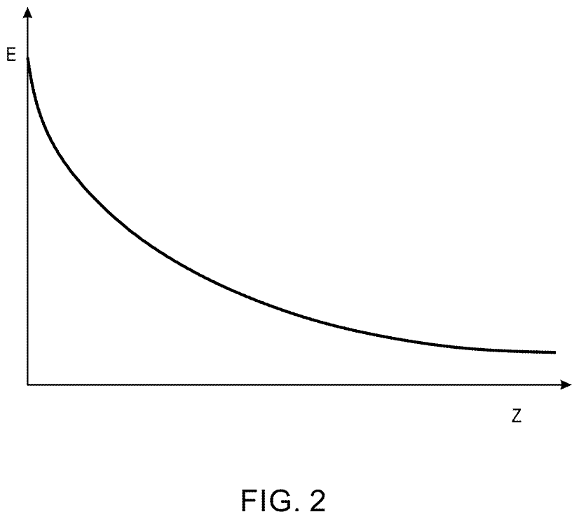

FIG. 2 depicts a graph of the energy of the beam (E) as a function of the penetration depth (z). Eq. 2 can be used to calculate energy of the beam as a function of the penetration depth at which the intensity of transmitted light drops to 1/e of its initial value (Iₒ). The power of the beam can be calculated from the energy as power=energy/time. The intensity of the beam can be calculated from the power of the beam as intensity=laser power/laser focal area.

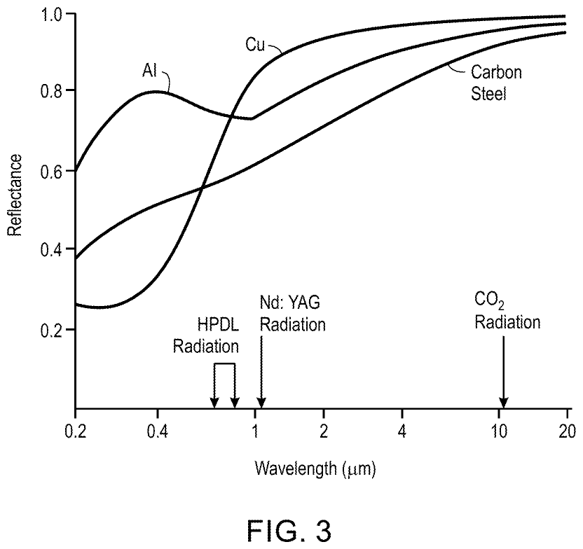

FIG. 3 depicts the reflectance of carbon steel, Cu and Al as a function of wavelength as well as the wavelengths of several lasers, where reflectance=(1−absorptance). For carbon steel, the carbon dioxide (CO₂) laser would be a good choice relative to the Nd:YAG laser or high-powered diode laser (HDPL) because the wavelength of the CO₂ laser corresponds to the highest reflectance and thus lowest absorptance.

In general, any appropriate laser can be used. Examples of the laser 1100 include a CO₂ laser, a fiber laser and a diode laser. In some embodiments, the CO₂ laser emits at a wavelength of at least 9 (e.g., at least 10, at least 10.6) μm and/or at most 11 (e.g., at most 10.6, at most 10) μm. In some embodiments, a CO₂ laser with an emission wavelength of 10.6 μm is used for a component 1200 that includes steel. In some embodiments, the Nd:YAG laser emits at a wavelength of 1064 nm; however, there are also transitions near 946, 1120, 1320, and 1440 nm. In some embodiments, the HPDL emits at a wavelength of at least 810 (e.g., at least 850, at least 900, at most 950) nm and/or at most 980 (e.g., at most 950, at most 900, at most 850).

The emissivity of several steels are presented in Table 1.

TABLE 1
Emissivity of various steels.

| | | |
|---|---|---|
| Material | Temp ° F. (° C.) | ε - emissivity |

| | | | |
|---|---|---|---|
| Cold rolled steel | 200 | (93) | 0.75-0.85 |
| Group sheet steel | 1720-2010 | (938-1099) | 0.55-0.61 |
| Polished sheet steel | 100 | (38) | 0.07 |
| Polished sheet steel | 500 | (260) | 0.10 |
| Polished sheet steel | 1000 | (538) | 0.14 |
| Mild steel, polished | 75 | (24) | 0.10 |
| Mild steel, smooth | 75 | (24) | 0.12 |
| Mild steel, liquid | 2910-3270 | (1599-1793) | 0.28 |
| Steel, unoxidized | 212 | (100) | 0.08 |
| Steel, oxidized | 77 | (25) | 0.80 |

The emissivity of a material depends on its effectiveness in emitting energy as thermal radiation, usually measured at a specific wavelength. The emissivity and absorption are characteristic of the material itself. The laser type and intensity can be controlled to achieve a target heat penetration.

Without wishing to be bound by theory, it is believed that the absorption and emissivity coefficient (e from Eq. 1) affect the penetration of the laser (Iₒ). Different wavelengths penetrate different distances into steel before most of the light is absorbed. Thus, laser sources with less absorbance and greater penetration can be more efficient at processing certain materials than others.

The beam power, beam diameter and scan speed of the laser 1100 can affect the size of the bake-out zone 1300. Decreasing the diameter of the beam generally leads to narrower and deeper penetration into the component 1200, whereas increasing the diameter of the beam generally increases the width of the bake-out zone 1300 but generally decreases the depth of exposure. Decreasing the scan speed generally increases the width and depth of the bake-out zone 1300.

In certain embodiments, the scan speed of the laser 1100 is selected based on the beam intensity of the laser 1100, the beam diameter of the laser 1100 and/or the thickness of the component 1200. For example, if the thickness is relatively high and the beam diameter is relatively large then the scan speed is reduced such that the heat penetration is achieved through the material.

In certain embodiments, the laser 1100 has an output power of at least 1 (e.g., at least 10, at least 100, at least 1,000, at least 10,000) W and/or at most 60,000 (e.g., at most 10,000, at most 1,000, at most 100, at most 10) W. In certain embodiments, the beam intensity of the laser 1100 is at least 1.5 (e.g., at least 2, at least 2.5) kW and/or at most 3 (e.g., at most 2.5, at most 2) kW.

In certain embodiments, the beam diameter of the laser 1100 is at least 2.75 (e.g., at least 3, at least 3.25, at least 3.5, at least 3.75, at least 4, at least 4.15, at least 4.25, at least 4.5, at least 4.75, at least 5, at least 5.25, at least 5.5, at least 5.75, at least 6, at least 6.25, at least 6.5, at least 6.75, at least 7, at least 7.25) mm and/or at most 7.5 (e.g., at most 7.25, at most 7, at most 6.75, at most 6.5, at most 6.25, at most 6, at most 5.75, at most 5.5, at most 5.25, at most 5, at most 4.75, at most 4.5, at most 4.25, at most 4.15, at most 4, at most 3.75, at most 3.5, at most 3.25, at most 3) mm.

In certain embodiments, the scan speed of the laser 1100 is at least 3 (e.g., at least 3.5, at least 4, at least 4.5, at least 5, at least 5.5, at least 6, at least 6.5, at least 7, at least 7.5, at least 8, at least 8.5, at least 9, at least 9.5, at least 10, at least 10.5, at least 11, at least 11.5, at least 12, at least 12.5, at least 13) m/min and/or at most 13.15 (e.g., at most 13, at most 12.5, at most 12, at most 11.5, at most 11, at most 10.5, at most 10, at most 9.5, at most 9, at most 8.5, at most 8, at most 7.5, at most 7, at most 6.5, at most 6, at most 5.5, at most 5, at most 4.5, at most 4, at most 3.5) m/min.

In certain embodiments, the laser 1100 can be transported manually by an operator. In certain embodiments, the transportation of the laser 1100 can be automated, such as using a crawler robot over the surface of the component 1200.

The duration of the exposure by the laser 1100 for a given bake-out zone 1300 in the method 1000 depends on the thickness of the component 1200, physical properties of the component 1200 (e.g., tensile strength, hardness), the temperature to which the component 1200 is heated and/or the amount of hydrogen in the component 1200. Without wishing to be bound by theory, it is believed that the bake-out time decreases by increasing the bake-out temperature and/or by decreasing the material thickness. The strength and hardness are characteristics of the material that influence how trapped the hydrogen is within the structure. With increasing hardness, the hydrogen will more be trapped, thus that higher temperatures and/or exposure times are desired to bake-out the hydrogen.

In general, the amount of hydrogen in the component 1200 before and after applying the method 1000 depends on the composition of the component 1200, the parameters of the bake-out (e.g., laser wavelength, laser intensity) and/or the nature of the hydrogen trapping. For example, in certain embodiments, some hydrogen is trapped irreversibly which cannot be removed by baking, whereas certain traps may be reversible allowing for removal of the hydrogen by baking.

In some embodiments, the amount of hydrogen in the component 1200 is at least 0.5 (e.g., at least 0.55, at least 0.6, at least 0.65) μA/cm² and/or at most 0.7 (e.g., at most 0.65, at most 0.6, at most 0.55) μA/cm² prior to baking. In some embodiments, the amount of hydrogen in the component 1200 is at least 0.35 (e.g., at least 0.4, at least 0.45, at least 0.5, at least 0.55) LA/cm² and/or at most 0.6 (e.g., at most 0.55, at most 0.5, at most 0.45, at most 0.4) A/cm² after baking. In some embodiments, at least 1 (e.g., at least 5, at least 10, at least 20, at least 30, at least 40, at least 50, at least 60, at least 70, at least 80, at least 90, at least 95, at least 99) % and/or at most 100 (e.g., at most 99.99, at most 99.9, at most 99.8, at most 99.5, at most 99, at most 98, at most 95, at most 90, at most 80, at most 70, at most 60, at most 50, at most 40, at most 30, at most 20, at most 10, at most 5) % of the hydrogen present in the component 1200 is removed by the bake-out.

The temperature of the component 1200 created by the laser 1100 should be selected such that the microstructure of the component 1200 is not impacted (e.g., less than 700° C.). The laser 1100 should not heat the component 1200 to a temperature at which the component 1200 will undergo an undesirable transformation and/or the microstructure will be impacted. For example, steel is transformed to austenite at a temperature of 727° C., thus if the component 1200 includes steel, the laser 1100 should not heat the component 1200 to a temperature of 727° C. In certain embodiments, a temperature generated by the laser is at least 315 (e.g., at least 320, at least 330, at least 340, at least 350, at least 360, at least 370, at least 380, at least 390, at least 400, at least 410, at least 420) ° C. and/or at most 426 (e.g., at most 420, at most 410, at most 400, at most 390, at most 380, at most 370, at most 360, at most 350, at most 340, at most 330, at most 320) ° C.

In general, the component 1200 includes a metal. Examples of the metal in the component 1200 include steel, iron, nickel, titanium, cobalt, aluminum and copper, and alloys thereof. In general, the component 1200 can be any type of steel or steel alloy.

The width of the bake-out zone 1300 generally depends on the laser beam diameter and usually should be selected to cover a desired area. In certain embodiments, the bake-out zone 1300 has a depth of at least 10 (e.g., at least 20, at least 30, at least 40, at least 50, at least 60, at least 70, at least 80, at least 90, at least 95, at least 98, at least 99) % and/or at most 100 (e.g., at most 99.99, at most 99.9, at most 99.8, at most 99.5, at most 99, at most 98, at most 95, at most 90, at most 80, at most 70, at most 60, at most 50, at most 40, at most 30, at most 20) % of the thickness of the component 1200.

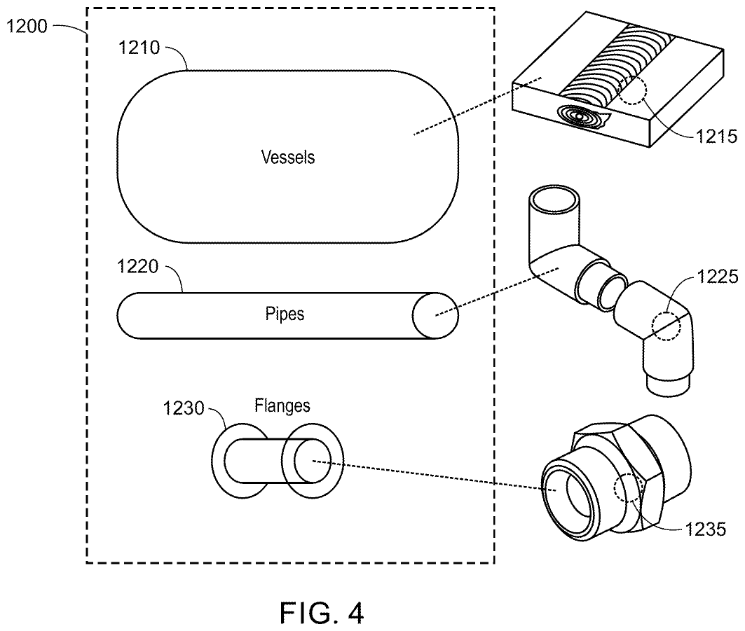

FIG. 4 depicts examples of the component 1200. The component 1200 can include a vessel 1210, a pipe 1220 and/or a flange 1230. The method can be used on a weld area 1215 of the vessel 1210, an elbow joint 1225 of the pipe 1220 and/or a high stress area 1235 of the flange 1230. The method 1000 can be applied in hard to reach areas of the component 1200 and provide relatively uniform heating of the component 1200. Examples of the vessel 1210 include steel pressure vessels, such as those in a pressurized water reactor system.

In some embodiments, the component 1200 can be heated while present in a system, such as an oil and gas system, such as an oil and gas production system (e.g., an oil and gas well), an oil and gas transportation system (e.g., a transportation pipeline), or an oil and gas processing system (e.g., a gas-oil separation plant). In some embodiments, the component 1200 is a high pressure production trap, a separation vessel, a knockout drum, a heat exchanger, a pipeline, a flanges, or a pipeline elbow. The method can be applied while the component 1200 is in place without disassembly.

In some embodiments, the method 1000 is performed prior to welding the material. Without wishing to be bound by theory, it is believed that heating the metal with a laser prior to welding can reduce (e.g., prevent) the accumulation of hydrogen at the weld site, which can result in hydrogen cracking during or after welding.

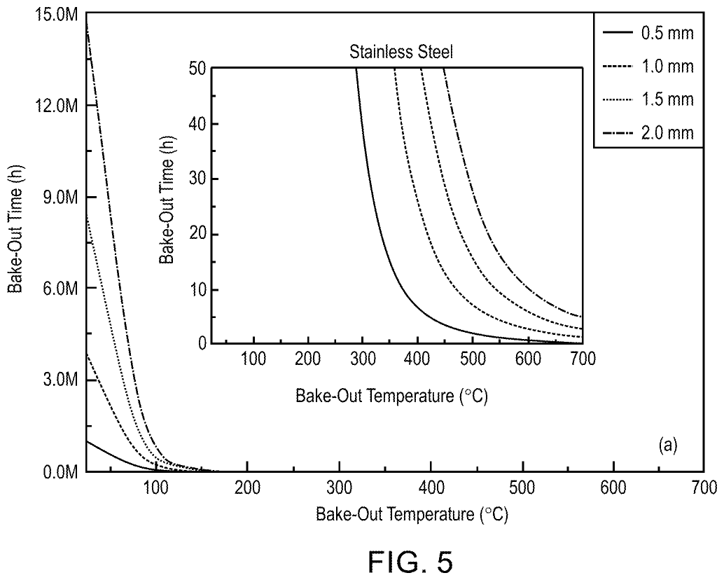

FIG. 5 depicts the bake-out time for stainless steel with different thicknesses as a function of bake-out temperature. The Ms on the y-axis correspond to million. The inset shows a zoom in of a region of the graph. In stainless steel, the bake-out time decreases as the bake-out temperature increases, as shown in FIG. 5. Lowering the material thickness reduced the bake-out time. Reduced thickness increased the rate of penetration of the laser beam and heat. Temperatures below 300° C. are considered to take a relatively long time to bake-out as hydrogen bake-out will not occur in stainless steel at these temperatures.

In general, the bake-out times for carbon steel vary based on the thickness of the material, properties of the material (e.g., tensile strength, hardness) and the temperature of the bake-out. Table 2 shows the bake-out times for carbon steel based on the thickness and bake-out time. Table 3 shows the hydrogen bake-out time for different grades of steel with different tensile strength and hardness.

TABLE 2
Bake-out times for carbon steel

| | Time (hours) | Time (hours) |
|---|---|---|
| Thickness (in) | at 800° F. | at 600° F. |
| 0.375 | 0.5 | 1 |
| 0.5 | 1 | 2 |
| 0.75 | 2 | 3 |
| 1.0 | 3 | 6 |
| 1.5 | 7 | 12 |
| 2.0 | 13 | 25 |

TABLE 3
Bake-out times for different grades of steel

| | | Time (Hrs.) Post |
|---|---|---|
| Tensile strength | Hardness | plate bake-out at 375- |

| MPA | KSI | (HRC) | 430° F. (190-220° C.) |
|---|---|---|---|
| 1700-1800 | 247-261 | 49-51 | 22+ |
| 1600-1700 | 232-247 | 47-49 | 20+ |
| 1500-1600 | 218-232 | 45-47 | 18+ |
| 1400-1500 | 203-218 | 43-45 | 16+ |
| 1300-1400 | 189-203 | 39-43 | 14+ |
| 1200-1300 | 174-189 | 36-39 | 12+ |
| 1100-1200 | 160-174 | 33-36 | 10++ |
| 1000-1100 | 145-160 | 31-33 | 8+ |

What is claimed is:

1. A method, comprising:
using a laser to heat a component comprising a material having a first hydrogen concentration to remove hydrogen from the material so that the material has a second hydrogen concentration which is less than the first hydrogen concentration,
wherein the material comprises a metal.

2. The method of claim 1, wherein the component comprises a member selected from the group consisting of a vessel, a pipe and a flange.

3. The method of claim 1, wherein, during the process of using the laser to heat the component, the component comprises a component of a system selected from the group consisting of an oil and gas production system, an oil and gas transportation system, and an oil and gas processing system.

4. The method of claim 1, wherein the metal comprises a member selected from the group consisting of steel, iron, nickel, titanium, cobalt, aluminum and copper.

5. The method of claim 1, wherein the metal comprises steel.

6. The method of claim 5, wherein the laser comprises a carbon dioxide laser.

7. The method of claim 6, wherein the laser has an average output power of 1 W to 60 kW.

8. The method of claim 7, wherein the laser emits at a wavelength of 9 μm to 11 μm.

9. The method of claim 8, wherein the laser has a beam diameter of 2.75 mm to 7.5 mm.

10. The method of claim 9, wherein the component is heated to a temperature of 315° C. to 426° C.

11. The method of claim 10, wherein the laser is scanned, and the laser has a scan speed of 3 m/min to 13.15 m/min.

12. The method of claim 11, wherein:
the first hydrogen concentration is 0.5 μA/cm² to 0.7 μA/cm²; and
the second hydrogen concentration is 0.35 μA/cm² to 0.6 μA/cm².

13. The method of claim 1, wherein the laser comprises a carbon dioxide laser.

14. The method of claim 1, wherein the laser has an average output power of 1 W to 60 kW.

15. The method of claim 1, wherein the laser emits at a wavelength of 9 μm to 11 μm.

16. The method of claim 1, wherein the component is heated to a temperature of 315° C. to 426° C.

17. The method of claim 1, wherein the laser has a beam diameter of 2.75 mm to 7.5 mm.

18. The method of claim 1, wherein the laser is scanned, and the laser has a scan speed of 3 m/min to 13.15 m/min.

19. The method of claim 1, wherein:
the first hydrogen concentration is 0.5 μA/cm² to 0.7 μA/cm²; and
the second hydrogen concentration is 0.35 μA/cm² to 0.6 μA/cm².

20. The method of claim 1, further comprising, before using the laser to heat the component, welding the component.
